(19) United States
(12) Patent Application Publication
(10) Pub. No.: US 2020/0034311 A1
(43) Pub. Date: Jan. 30, 2020

(54) MULTI-LEVEL STORAGE METHOD AND APPARATUS FOR BLOCKCHAIN DATA

(71) Applicant: Alibaba Group Holding Limited, George Town (KY)

(72) Inventor: Shifeng Wang, Hangzhou (CN)

(73) Assignee: Alibaba Group Holding Limited, George Town (KY)

(21) Appl. No.: 16/522,294

(22) Filed: Jul. 25, 2019

(30) Foreign Application Priority Data
Jul. 27, 2018 (CN) 201810847133.0

(51) Int. Cl. G06F 12/123; H04L 9/06; G06F 16/182

(52) U.S. Cl. CPC G06F 12/123; G06F 16/1827; H04L 9/0637

(57) ABSTRACT

One or more implementations shown in the present specification provide a multi-level storage method for blockchain data, in which. a latest block data of a blockchain is received. The latest block data is stored in a first-level storage system of the multi-level storage system, in which the multi-level storage system includes the first-level storage system and at least one lower-level storage system configured to archive block data previously stored in the first-level storage system. It is determined that a block data migration event for the first-level storage system is triggered. In response to determining that the block data migration event for the first-level storage system is triggered, at least a part of block data currently stored in the first-level storage system to the lower-level storage system is migrated.

### CROSS-REFERENCE TO RELATED APPLICATIONS

This application claims priority to Chinese Patent Application No. 201810847133.0, filed on Jul. 27, 2018, which is hereby incorporated by reference in its entirety.

### TECHNICAL FIELD

The present specification relates to the field of network communications technologies, and in particular, to a multi-level storage method and apparatus for blockchain data.

### BACKGROUND

A blockchain technology, also referred to as a distributed ledger technology, is an emerging technology in which several computing devices jointly participate in “accounting” and jointly maintain a complete distributed database. The blockchain technology is characterized by decentralization and transparency. Each computing device can participate in database recording as a node device of a blockchain, and computing devices can implement rapid data synchronization. Various node devices of the blockchain usually need to process a consensus operation, a verification operation, and a read/write operation with high concurrency in a blockchain system. As the number of blocks “entered in the ledger” increases, incremental block data storage gradually affects a response speed of a storage device and further affects the efficiency of the node devices in responding to the consensus operation, the verification operation, and the read/write operation with high concurrency.

### SUMMARY

For the previous problems, the present specification provides a multi-level storage method for blockchain data, where block data of the blockchain is stored in a multi-level storage system interconnected to the blockchain, the multi-level storage system includes the first-level storage system configured to store the latest block data of the blockchain, and at least one lower-level storage system configured to archive block data stored in the first-level storage system, and the method includes: receiving the latest block data of the blockchain, and storing the latest block data in the first-level storage system in the multi-level storage system; determining whether a block data migration event for the first-level storage system is triggered; and if yes, migrating at least a part of block data stored in the first-level storage system to the lower-level storage system.

Preferably, a single-chain connection way is used between various storage systems in the multi-level storage system.

Preferably, storage performance of a storage medium corresponding to the first-level storage system is higher than storage performance of a storage medium corresponding to the lower-level storage system.

Preferably, storage performance of storage media corresponding to various levels of storage systems in the multi-level storage system decreases in a gradient from the first-level storage system.

Preferably, the method further includes: determining whether any one of the lower-level storage systems receives the at least a part of block data migrated from the upper-level storage system; if yes, determining whether a block data migration event for the any one of the lower-level storage systems is triggered; and if yes, continuing migrating at least a part of block data stored in the any one of the lower-level storage systems to a lower-level storage system of the any one of the lower-level storage systems.

Preferably, the block data migration event for the first-level storage system includes: a data capacity of the block data stored in the first-level storage system exceeds a predetermined threshold, or a capacity ratio of a data capacity of the block data stored in the first-level storage system to a total data capacity of the first-level storage system exceeds a predetermined threshold.

Preferably, the block data migration event for the any one of the lower-level storage systems includes: a data capacity of block data stored in the any one of the lower-level storage systems exceeds a predetermined threshold, or a capacity ratio of a data capacity of block data stored in the any one of the lower-level storage systems to a total data capacity of the any one of the lower-level storage systems exceeds a predetermined threshold.

Correspondingly, the present specification further provides a multi-level storage apparatus for blockchain data, where block data of the blockchain is stored in a multi-level storage system interconnected to the blockchain, the multi-level storage system includes the first-level storage system configured to store the latest block data of the blockchain, and at least one lower-level storage system configured to archive block data stored in the first-level storage system, and the apparatus includes: a read/write unit, configured to receive the latest block data of the blockchain, and store the latest block data in the first-level storage system in the multi-level storage system; a determining unit, configured to determine whether a block data migration event for the first-level storage system is triggered; and a migration unit, configured to migrate at least a part of block data stored in the first-level storage system to the lower-level storage system if the determining unit determines that the block data migration event for the first-level storage system is triggered.

Preferably, a single-chain connection way is used between various storage systems in the multi-level storage system.

Preferably, storage performance of a storage medium corresponding to the first-level storage system is higher than storage performance of a storage medium corresponding to the lower-level storage system.

Preferably, storage performance of storage media corresponding to various levels of storage systems in the multi-level storage system decreases in a gradient from the first-level storage system.

Preferably, the determining unit is configured to determine whether any one of the lower-level storage systems receives the at least a part of block data migrated from the upper-level storage system; and if yes, determine whether a block data migration event for the any one of the lower-level storage systems is triggered; and the migration unit is configured to continue migrating at least a part of block data stored in the any one of the lower-level storage systems to a lower-level storage system of the any one of the lower-level storage systems if the determining unit of the lower-level storage system determines that the block data migration event for the any one of the lower-level storage systems is triggered.

Preferably, the block data migration event for the first-level storage system includes: a data capacity of the block data stored in the first-level storage system exceeds a predetermined threshold, or a capacity ratio of a data capacity of the block data stored in the first-level storage system to a total data capacity of the first-level storage system exceeds a predetermined threshold.

Preferably, the block data migration event for the any one of the lower-level storage systems includes: a data capacity of block data stored in the any one of the lower-level storage systems exceeds a predetermined threshold, or a capacity ratio of a data capacity of block data stored in the any one of the lower-level storage systems to a total data capacity of the any one of the lower-level storage systems exceeds a predetermined threshold.

Correspondingly, the present specification further provides a computer device, including a storage device and a processor. The storage device stores a computer program that can be run by the processor. When running the computer program, the processor performs steps in the previous blockchain data storage method.

The present specification further provides a computer-readable storage medium. The computer-readable storage medium stores a computer program, and when the computer program is run by a processor, steps in the previous blockchain data storage method are performed.

According to the blockchain data storage method and apparatus, the computer device, and the computer storage medium provided in the present specification, at least a part of block data in the first-level storage system is migrated to a lower-level storage system in the multi-level storage system under triggering of a related migration trigger event, to release more storage space for the first-level storage system, so that the first-level storage system can better perform various data operations such as a consensus operation, a verification operation, and a read/write operation with high concurrency that are generated in the blockchain. Because of a tamper-resistant characteristic of the blockchain, data that has been recorded in a historical block cannot be deleted or modified, and operation of adding data to the historical block also cannot be performed. Only a read operation can be performed on block data migrated to a lower-level storage system in the multi-level storage system. Therefore, the previous lower-level storage system can be deployed by using a hardware device resource with a relatively low performance configuration, to reduce costs of the entire storage system.

### BRIEF DESCRIPTION OF DRAWINGS

FIG. 1 is a flowchart illustrating a multi-level storage method for blockchain data, according to an example implementation of the present specification;

FIG. 2 (a) is an architectural diagram illustrating a multi-level storage system, according to an example implementation of the present specification;

FIG. 2 (b) is an architectural diagram illustrating a multi-level storage system, according to another example implementation of the present specification;

FIG. 3 is a schematic diagram illustrating a multi-level storage apparatus for blockchain data, according to an example implementation of the present specification;

FIG. 4 is a structural diagram illustrating hardware for running an implementation of a multi-level storage method or apparatus for blockchain data, according to the present specification.

### DESCRIPTION OF IMPLEMENTATIONS

The “blockchain” described in the implementations provided in the present specification can be a P2P network system that is implemented by various node devices by using a consensus mechanism having a distributed data storage structure. Data in the blockchain is distributed within “blocks” that are connected in terms of time. The latter block includes a data digest of a previous block, and data of all or some nodes is fully backed up based on different consensus mechanisms (e.g., a Proof of Work (PoW), a Proof of Stake (PoS), a Delegated Proof of Stake (DPoS), or a Practical Byzantine Fault Tolerance (PBFT)). Various node devices (especially a full node device) of the blockchain usually need to process a consensus operation, a verification operation, and a read/write operation with high concurrency in a blockchain system. As the number of blocks “entered in the ledger” increases, incremental block data storage gradually affects a response speed of a storage device, and further affects the efficiency of the node devices in responding to the consensus operation, the verification operation, and the read/write operation with high concurrency.

The present specification aims to provide a multi-level storage method or apparatus for blockchain data. Block data of the blockchain is stored in a multi-level storage system interconnected to the blockchain. The multi-level storage system includes the first-level storage system configured to store the latest block data of the blockchain, and at least one lower-level storage system configured to archive block data stored in the first-level storage system.

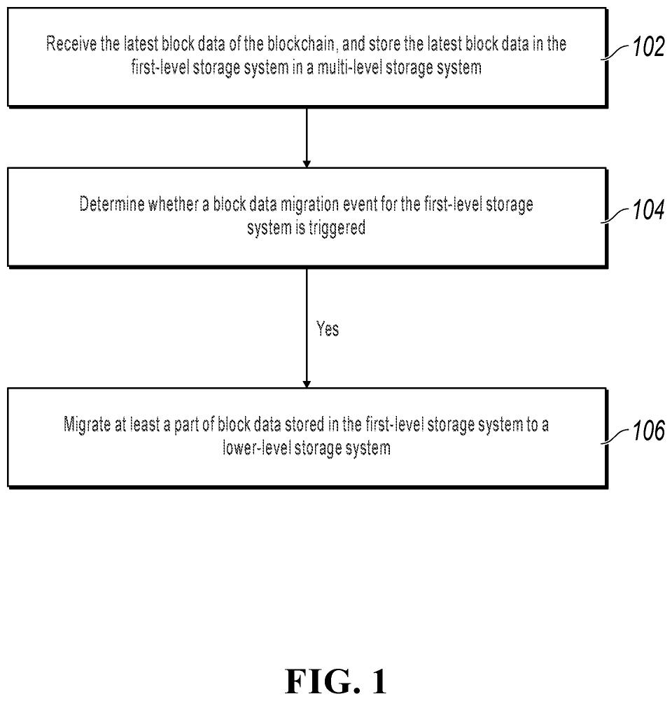

FIG. 1 is a flowchart illustrating a multi-level storage method for blockchain data, according to an example implementation of the present specification, and the method includes the following steps:

Step 102: Receive the latest block data of the blockchain, and store the latest block data in the first-level storage system in a multi-level storage system.

Step 104: Determine whether a block data migration event for the first-level storage system is triggered.

If yes, the following step 106 is performed: migrate at least a part of block data stored in the first-level storage system to a lower-level storage system.

The first-level storage system in the previous implementation is configured to store the latest block data of the blockchain. In addition, the first-level storage system can be further configured to process a data operation service (including a consensus operation, a verification operation, and a read/write operation performed on the block data) related to the generation of the latest block data in the blockchain. Due to multi-node and high-concurrency service demands of the blockchain, a storage medium with high storage performance (e.g., high bandwidth, a high processing rate, and large capacity) is usually selected for the first-level storage system. As more blocks are packaged in the blockchain, remaining storage space in the first-level storage system gradually decreases, and a data processing capability of the first-level storage system such as a capability of performing consensus, verification, and read/write on the block data gradually decreases. Therefore, the storage system needs to migrate at least a part of block data in the first-level storage system to a lower-level storage system of the first-level storage system in the multi-level storage system.

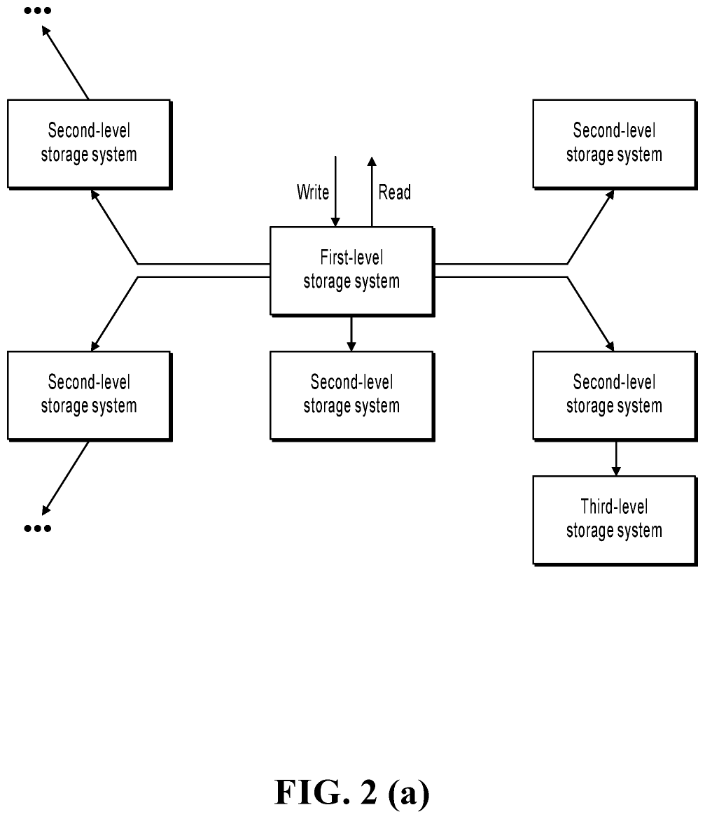

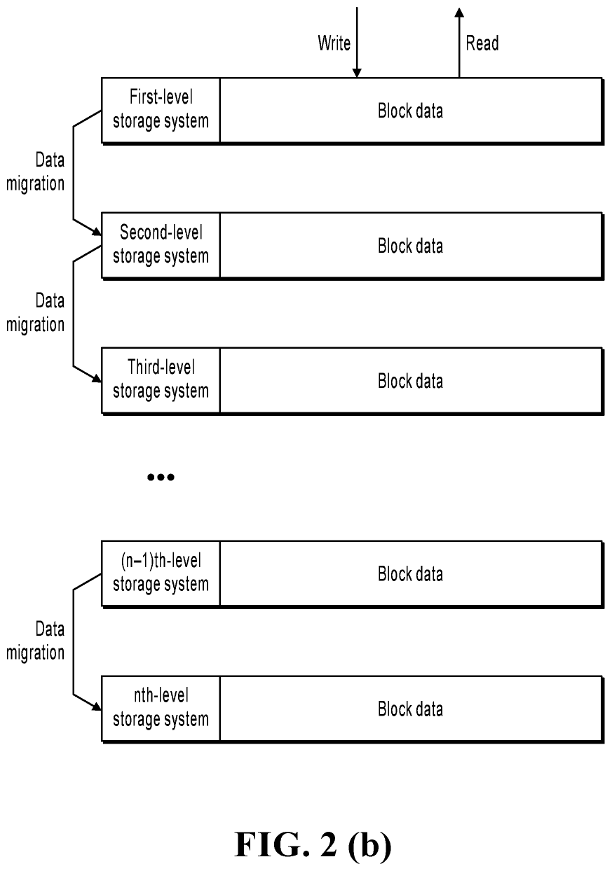

The multi-level storage system in the previous implementation can be in several architectural forms. FIG. 2 (a) and FIG. 2 (b) show two possible architectural forms of the multi-level storage system provided in the present specification. In FIG. 2 (a), the first-level storage system has a number of lower-level storage systems, such as second-level storage systems shown in FIG. 2(a). Block data in the first-level storage system can be separately migrated to different second-level storage systems based on settings of the storage system. In addition, the second-level storage systems can be further connected to several third-level storage systems based on specific blockchain data storage demands. Implementations are not limited in the present specification. The storage system shown in FIG. 2 (b) is a multi-level storage system that starts from the previously described first-level storage system and in which a number of lower-level storage systems are connected in a single-chain mode. Various storage system in the multi-level storage system are connected in a single-chain connection way. In the multi-level storage system of such an architecture, block data in the first-level storage system is unidirectionally migrated.

The at least one lower-level storage system in the previous implementation is a storage system other than the first-level storage system in the multi-level storage system. The migration of at least a part of block data stored in the first-level storage system to a lower-level storage system in the previous implementation can include many migrating ways. For example, at least a part of block data stored in the first-level storage system is migrated to a lower-level storage system connected to the first-level storage system, or at least a part of block data stored in the first-level storage system is migrated to several lower-level storage systems connected to the first-level storage system. Implementations are not limited in the present specification.

The block data in the previous implementation includes all data in a block in the blockchain. When index data established for all data in each block is further set in a blockchain database, the block data further includes the index data corresponding to each block. The index data generally includes content such as a block digest value (hash value) index, a transaction digest value (hash value) index, and a historical transaction status data index that are for each block. The historical transaction status data is a historical value of transaction status in the blockchain, for example, a total balance of a chain account corresponding to a certain block. Therefore, the migration of at least a part of block data described in the present specification can be performed in several ways, for example, all data in at least some blocks in the blockchain can be migrated, or index data corresponding to the at least some blocks can be migrated with the blocks, or a part of index data corresponding to the at least some blocks can be migrated with the blocks. A person skilled in the existing technology can determine a block data migration way in the multi-level storage system based on specific demands. Implementations are not limited in the present specification.

The determining whether a block data migration event for the first-level storage system is triggered in the previous implementation includes: determining whether block data stored in the first-level storage system satisfies a predetermined data migration trigger rule. Specifically, the data migration trigger rule can include the following: A data capacity of the block data stored in the first-level storage system is greater than a predetermined threshold, or a capacity ratio of a data capacity of the block data stored in the first-level storage system to a total data capacity of the first-level storage system exceeds a predetermined threshold. Based on a data type included in the block data, block data used for determining by using the trigger rule can include one or more of total data, transaction digest value data, block digest value data, and historical status data in a block.

For example, whether a total data capacity of an existing block in the blockchain in the first-level storage system exceeds a predetermined threshold is queried. If the total data capacity exceeds the threshold, a migration operation is initiated, and block data stored in the first-level storage system before a migration reference time is migrated to the second-level storage system, where the block data includes total data in each block or total data in each block and index data related to the total data in each block. When the previous migration reference time is a specific block height value, migration of the block data before the block height value can be directly initiated. When the migration reference time is a specific physical time (e.g., a time point or a time stamp), the physical time can be first converted into a specific block height value, then migration of the block data before the block height value is initiated. The block data before the migration reference time includes the total data in each block or the total data in each block and the index data related to the total data in each block, that is, the at least a part of block data described in the previous implementation.

For another example, when related index data is further set in the blockchain database, for the blockchain of which a transaction is a main service form, whether a capacity of the transaction digest value data of the blockchain in the first-level storage system exceeds a threshold or whether a capacity ratio of the transaction digest value data to the total data capacity of the first-level storage system exceeds a predetermined threshold is queried. If the capacity exceeds the threshold, or if the capacity ratio exceeds the threshold, the migration operation is initiated, the block data that is stored in the first-level storage system before the migration reference time is migrated to the second-level storage system. Similarly, other index data in the blockchain database can also be used as a monitoring object set for the migration trigger rule, to monitor a capacity or a capacity ratio of the previous historical status data, to trigger the migration operation.

The previous data migration trigger rule or a migration trigger operation is generally set and executed by a computer program. It can be understood that an execution program in which the data migration trigger rule is set can be arranged in a node device of the blockchain, and monitor storage status of the first-level storage system, so that the execution program is executed based on the migration trigger rule. It is worthwhile to note that when a computer program performs monitoring, responds to a detected migration trigger event for the block data stored in the first-level storage system, and performs a corresponding migration operation, the computer program can invoke a data migration utility program in the blockchain, to migrate at least a part of block data in the first-level storage system to a lower-level storage system of the first-level storage system.

In another implementation, the data migration trigger rule and the migration trigger operation can be determined and manually performed by a user. For example, a user of a node device of the blockchain that the first-level storage system is located actively enters a migration instruction based on the user's understanding and determination of existing status of the first-level storage system. It also can be a node device system of the blockchain invokes some other programs in the system or related smart contract programs to trigger a migration instruction. Implementations are not limited in the present specification.

According to the blockchain data storage method provided in the previous implementations, at least a part of block data in the first-level storage system is migrated to a lower-level storage system in the multi-level storage system under triggering of a related migration trigger event, to release more storage space for the first-level storage system, so that the first-level storage system can better perform various data operations such as a consensus operation, a verification operation, and a read/write operation with high concurrency that are generated in the blockchain. Because of a tamper-resistant characteristic of the blockchain, data that has been recorded in a historical block cannot be deleted or modified, and an operation of adding data to the historical block also cannot be performed. Only a read operation can be performed on block data migrated to a lower-level storage system in the multi-level storage system. Therefore, the previous lower-level storage system can be deployed by using a hardware device resource with a relatively low performance configuration, to reduce costs of the entire storage system.

When the previous multi-level storage system is a single-chain multi-level storage system as shown in FIG. 2 (b), the second-level storage system in the multi-level storage system receives the at least a part of block data migrated from the first-level storage system. A person skilled in the existing technology knows that, after receiving the block data migrated from the upper-level storage system, the second-level storage system needs to confirm whether existing data storage triggers a block data migration event for the second-level storage system because stored data is added. If yes, the second-level storage system also needs to migrate at least a part of block data to a lower-level storage system of the second-level storage system, that is, the third-level storage system. Likewise, after receiving the block data migrated from the upper-level storage system, the third-level storage system needs to confirm whether existing data storage triggers a block data migration event for the third-level storage system because stored data is added. If yes, the third-level storage system also needs to migrate at least a part of block data to a lower-level storage system of the third-level storage system, namely, the fourth-level storage system. Similar processes can be followed by analogy.

Therefore, in another example implementation provided in the present specification, for the multi-level storage system in a single-chain architecture, the blockchain data storage method further includes: determining whether any one of the lower-level storage systems receives the at least a part of block data migrated from the upper-level storage system; if yes, determining whether a block data migration event for the any one of the lower-level storage systems is triggered; and if yes, continuing migrating at least a part of block data stored in the any one of the lower-level storage systems to a lower-level storage system of the any one of the lower-level storage systems.

The triggering a block data migration event for the any one of the lower-level storage systems in the previous implementation is similar to the triggering the block data migration event for the first-level storage system in the previous implementation, and can include the following: A data capacity of block data stored in the any one of the lower-level storage systems is greater than a predetermined threshold, or a capacity ratio of data capacity of block data stored in the any one of the lower-level storage systems to a total data capacity of the any one of the lower-level storage systems is greater than a predetermined threshold. Based on a data type included in the block data, block data used for determining by using a trigger rule can include one or more of total data, transaction digest value data, block digest value data, and historical status data in a block. A process of determining whether a trigger event occurs and migrating at least a part of block data to a lower-level storage system for the any one of the lower-level storage systems is similar to a process of determining whether a trigger event occurs and migrating at least a part of block data to a lower-level storage system for the first-level storage system. Details are omitted here for simplicity.

It is worthwhile to note that in the previous multi-level storage system, block data migration trigger events for each level of storage system can be the same or can be different. For example, values of predetermined thresholds corresponding to the block data migration trigger events for each level of storage system can be the same or can be different. Alternatively, block data migration trigger events for some levels of storage systems are that a data capacity of block data stored in the storage systems is greater than a predetermined threshold, block data migration trigger events for other levels of storage systems are that capacity ratios of block data stored in the storage systems to total data capacities of the some levels of storage systems are greater than a predetermined threshold, and even block data migration trigger events for some levels of storage systems are migration instructions entered by a user. A person skilled in the existing technology can set a corresponding data migration trigger event for each level of the storage system in the multi-level storage system based on a specific data storage demand, to increase adaptability and flexibility of the multi-level storage system provided in the present specification.

Because a blockchain system runs under a corresponding consensus mechanism, data that has been recorded in the blockchain database is difficult to be tampered with by any node. For example, in a blockchain that uses a PoW consensus, existing data may be tampered with by an attack with at least 51% hash rate in the entire network. Therefore, the blockchain system has characteristics of ensuring data security and preventing attack and tampering that other centralized database systems cannot achieve. Because an existing block that has been recorded by various node devices in the blockchain through a consensus cannot be tampered with, and only a read operation can be performed on the existing block, performance of a storage medium corresponding to the lower-level storage system that receives the at least a part of block data migrated from the first-level storage system is lower than performance of the storage medium corresponding to the first-level storage system. Optionally, in the single-chain multi-level storage system shown in FIG. 2 (b), because data in the blockchain is distributed within “blocks” that are connected in terms of time, a relatively long-history data has a lower probability of being read by a user, and storage performance of storage media corresponding to the chained multi-level storage system can decrease in a gradient from the first-level storage system. Historical data in a blockchain can be archived and stored through the previous chained multi-level migration, so that storage resource can be properly allocated, and consensus read/write efficiency of a blockchain system can be improved.

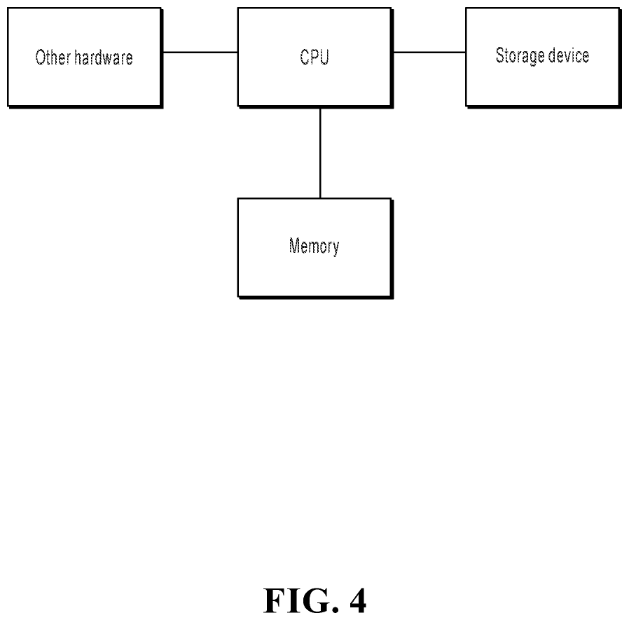

Corresponding to previous procedure implementation, an implementation of the present specification further provides a blockchain data storage apparatus. The apparatus can be implemented by software, can be implemented by hardware, or can be implemented by a combination of hardware and software. Software implementation is used as an example. As a logical apparatus, the software is formed by reading a corresponding computer program instruction in a memory and running the instruction in the memory by a central processing unit (CPU) in a device that the software is located. In terms of hardware, in addition to a CPU, memory, and a storage device shown in FIG. 4, a device in which the blockchain-based data migration apparatus is located generally further includes other hardware such as a chip for sending and receiving radio signals, and/or other hardware such as a card configured to implement a network communication function.

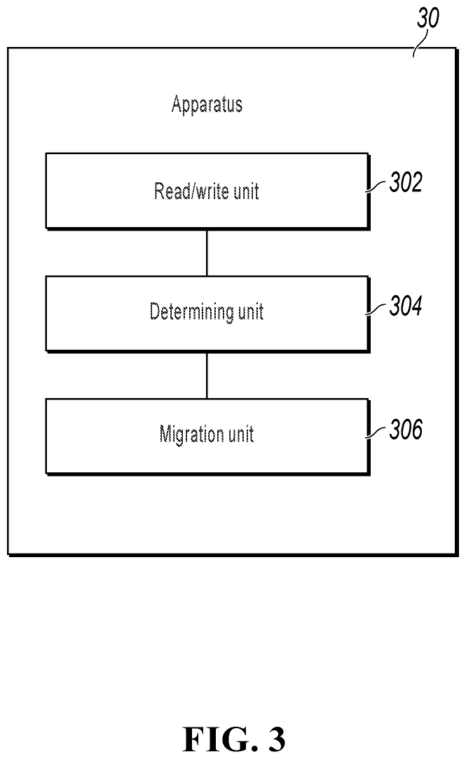

FIG. 3 is a blockchain data storage apparatus 30 provided in the present specification. Block data of the blockchain is stored in a multi-level storage system interconnected to the blockchain, the multi-level storage system includes the first-level storage system configured to store the latest block data of the blockchain, and at least one lower-level storage system configured to archive block data stored in the first-level storage system, and the apparatus 30 includes: a read/write unit 302, configured to receive the latest block data of the blockchain, and store the latest block data in the first-level storage system in the multi-level storage system; a determining unit 304, configured to determine whether a block data migration event for the first-level storage system is triggered; and a migration unit 306, configured to migrate at least a part of block data stored in the first-level storage system to the lower-level storage system if the determining unit determines that the block data migration event for the first-level storage system is triggered.

Preferably, a single-chain connection way is used between various storage systems in the multi-level storage system.

Preferably, storage performance of a storage medium corresponding to the first-level storage system is higher than storage performance of a storage medium corresponding to the lower-level storage system.

Preferably, storage performance of storage media corresponding to various levels of storage systems in the multi-level storage system decreases in a gradient from the first-level storage system.

Preferably, the determining unit is configured to determine whether any one of the lower-level storage systems receives the at least a part of block data migrated from the upper-level storage system; and if yes, determine whether a block data migration event for the any one of the lower-level storage systems is triggered; and the migration unit is configured to continue migrating at least a part of block data stored in the any one of the lower-level storage systems to a lower-level storage system of the any one of the lower-level storage systems if the determining unit of the lower-level storage system determines that the block data migration event for the any one of the lower-level storage systems is triggered.

Preferably, the block data migration event for the first-level storage system includes: a data capacity of the block data stored in the first-level storage system exceeds a predetermined threshold, or a capacity ratio of a data capacity of the block data stored in the first-level storage system to a total data capacity of the first-level storage system exceeds a predetermined threshold.

Preferably, the block data migration event for the any one of the lower-level storage systems includes: a data capacity of block data stored in the any one of the lower-level storage systems exceeds a predetermined threshold, or a capacity ratio of a data capacity of block data stored in the any one of the lower-level storage systems to a total data capacity of the any one of the lower-level storage systems exceeds a predetermined threshold.

For an implementation process of functions and roles of each unit in the apparatus, references can be made to an implementation process of corresponding steps in the previous method. For related parts, references can be made to partial descriptions in the method implementation. Details are omitted here for simplicity.

The previously described apparatus implementation is merely an example. The units described as separate parts may or may not be physically separate, and parts displayed as units may or may not be physical modules, may be located in one position, or may be distributed on several network modules. Some or all of the units or modules can be selected based on actual demands to achieve the objectives of the solutions of the present specification. A person of ordinary skill in the existing technology can understand and implement the implementations of the present specification without creative efforts.

The apparatus and units illustrated in the previous implementations can be implemented by a computer chip or an entity or can be implemented by a product with a certain function. A typical implementation device is a computer, and the computer can be a personal computer, a laptop computer, a cellular phone, a camera phone, a smartphone, a personal digital assistant, a media player, a navigation device, an email receiving and sending device, a game console, a tablet computer, a wearable device, or any combination of these devices.

Corresponding to the previous method implementations, an implementation of the present specification further provides a computer device. The computer device includes a storage device and a processor. The storage device stores a computer program that can be run by the processor. When running the stored computer program, the processor performs steps of the blockchain-based data migration method in the implementations of the present specification. For a detailed description of steps of the blockchain-based data migration method, references can be made to the previous content. Details are omitted here.

Corresponding to the previous method implementations, an implementation of the present specification further provides a computer-readable storage medium. The storage medium stores a computer program. When the computer program is run by a processor, steps of the blockchain-based work copyright income distribution method in the implementations of the present specification are performed. For a detailed description of steps of the blockchain-based data migration method, references can be made to the previous content. Details are omitted here.

The previous descriptions are merely example implementations of the present specification but are not intended to limit the present specification. Any modification, equivalent replacement, or improvement made without departing from the spirit and principle of the present specification shall fall within the protection scope of the present specification.

In a typical configuration, a computing device includes one or more processors (CPU), an input/output interface, a network interface, and a memory.

The memory may include a non-persistent memory, a random access memory (RAM), and/or a non-volatile memory in a computer-readable medium, for example, a read-only memory (ROM) or a flash memory (flash RAM). The memory is an example of the computer-readable medium.

The computer-readable medium includes persistent, non-persistent, movable, and unmovable media that can store information by using any method or technology. The information can be a computer-readable instruction, a data structure, a program module, or other data.

Examples of a computer storage medium include but are not limited to a phase change memory (PRAM), a static random access memory (SRAM), a dynamic random access memory (DRAM), another type of random access memory (RAM), a read-only memory (ROM), an electrically erasable programmable read-only memory (EEPROM), a flash memory or another memory technology, a compact disc read-only memory (CD-ROM), a digital versatile disc (DVD) or another optical storage, a cassette magnetic tape, a magnetic tape/magnetic disk storage or another magnetic storage device. The computer storage medium can be used to store information that can be accessed by the computing device. Based on the description in the present specification, the computer-readable medium does not include transitory computer-readable media (transitory media) such as a modulated data signal and carrier.

It is worthwhile to further note that the terms “include”, “contain”, or their any other variants are intended to cover a non-exclusive inclusion, so that a process, a method, a product, or a device that includes a list of elements not only includes those elements but also includes other elements that are not expressly listed, or further includes elements inherent to such process, method, product, or device. Without more constraints, an element preceded by “includes a . . . ” does not preclude the existence of additional identical elements in the process, method, product, or device that includes the element.

A person skilled in the existing technology should understand that an implementation of the present specification can be provided as a method, a system, or a computer program product. Therefore, the implementations of the present specification can use a form of hardware only implementations, software only implementations, or implementations with a combination of software and hardware. Moreover, the implementations of the present specification can use a form of a computer program product that is implemented on one or more computer-usable storage media (including but not limited to a disk memory, a CD-ROM, an optical memory, etc.) that include computer-usable program code.

Embodiments and the operations described in this specification can be implemented in digital electronic circuitry, or in computer software, firmware, or hardware, including the structures disclosed in this specification or in combinations of one or more of them. The operations can be implemented as operations performed by a data processing apparatus on data stored on one or more computer-readable storage devices or received from other sources. A data processing apparatus, computer, or computing device may encompass apparatus, devices, and machines for processing data, including by way of example a programmable processor, a computer, a system on a chip, or multiple ones, or combinations, of the foregoing. The apparatus can include special purpose logic circuitry, for example, a central processing unit (CPU), a field programmable gate array (FPGA) or an application-specific integrated circuit (ASIC). The apparatus can also include code that creates an execution environment for the computer program in question, for example, code that constitutes processor firmware, a protocol stack, a database management system, an operating system (for example an operating system or a combination of operating systems), a cross-platform runtime environment, a virtual machine, or a combination of one or more of them. The apparatus and execution environment can realize various different computing model infrastructures, such as web services, distributed computing and grid computing infrastructures.

A computer program (also known, for example, as a program, software, software application, software module, software unit, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A program can be stored in a portion of a file that holds other programs or data (for example, one or more scripts stored in a markup language document), in a single file dedicated to the program in question, or in multiple coordinated files (for example, files that store one or more modules, sub-programs, or portions of code). A computer program can be executed on one computer or on multiple computers that are located at one site or distributed across multiple sites and interconnected by a communication network.

Processors for execution of a computer program include, by way of example, both general- and special-purpose microprocessors, and any one or more processors of any kind of digital computer. Generally, a processor will receive instructions and data from a read-only memory or a random-access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data. A computer can be embedded in another device, for example, a mobile device, a personal digital assistant (PDA), a game console, a Global Positioning System (GPS) receiver, or a portable storage device. Devices suitable for storing computer program instructions and data include non-volatile memory, media and memory devices, including, by way of example, semiconductor memory devices, magnetic disks, and magneto-optical disks. The processor and the memory can be supplemented by, or incorporated in, special-purpose logic circuitry.

Mobile devices can include handsets, user equipment (UE), mobile telephones (for example, smartphones), tablets, wearable devices (for example, smart watches and smart eyeglasses), implanted devices within the human body (for example, biosensors, cochlear implants), or other types of mobile devices. The mobile devices can communicate wirelessly (for example, using radio frequency (RF) signals) to various communication networks (described below). The mobile devices can include sensors for determining characteristics of the mobile device's current environment. The sensors can include cameras, microphones, proximity sensors, GPS sensors, motion sensors, accelerometers, ambient light sensors, moisture sensors, gyroscopes, compasses, barometers, fingerprint sensors, facial recognition systems, RF sensors (for example, Wi-Fi and cellular radios), thermal sensors, or other types of sensors. For example, the cameras can include a forward- or rear-facing camera with movable or fixed lenses, a flash, an image sensor, and an image processor. The camera can be a megapixel camera capable of capturing details for facial and/or iris recognition. The camera along with a data processor and authentication information stored in memory or accessed remotely can form a facial recognition system. The facial recognition system or one-or-more sensors, for example, microphones, motion sensors, accelerometers, GPS sensors, or RF sensors, can be used for user authentication.

To provide for interaction with a user, embodiments can be implemented on a computer having a display device and an input device, for example, a liquid crystal display (LCD) or organic light-emitting diode (OLED)/virtual-reality (VR)/augmented-reality (AR) display for displaying information to the user and a touchscreen, keyboard, and a pointing device by which the user can provide input to the computer. Other kinds of devices can be used to provide for interaction with a user as well; for example, feedback provided to the user can be any form of sensory feedback, for example, visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments can be implemented using computing devices interconnected by any form or medium of wireline or wireless digital data communication (or combination thereof), for example, a communication network. Examples of interconnected devices are a client and a server generally remote from each other that typically interact through a communication network. A client, for example, a mobile device, can carry out transactions itself, with a server, or through a server, for example, performing buy, sell, pay, give, send, or loan transactions, or authorizing the same. Such transactions may be in real time such that an action and a response are temporally proximate; for example an individual perceives the action and the response occurring substantially simultaneously, the time difference for a response following the individual's action is less than 1 millisecond (ms) or less than 1 second (s), or the response is without intentional delay taking into account processing limitations of the system.

Examples of communication networks include a local area network (LAN), a radio access network (RAN), a metropolitan area network (MAN), and a wide area network (WAN). The communication network can include all or a portion of the Internet, another communication network, or a combination of communication networks. Information can be transmitted on the communication network according to various protocols and standards, including Long Term Evolution (LTE), 5G, IEEE 802, Internet Protocol (IP), or other protocols or combinations of protocols. The communication network can transmit voice, video, biometric, or authentication data, or other information between the connected computing devices.

Features described as separate implementations may be implemented, in combination, in a single implementation, while features described as a single implementation may be implemented in multiple implementations, separately, or in any suitable sub-combination. Operations described and claimed in a particular order should not be understood as requiring that the particular order, nor that all illustrated operations must be performed (some operations can be optional). As appropriate, multitasking or parallel-processing (or a combination of multitasking and parallel-processing) can be performed.

What is claimed is:

1. A computer-implemented method for storing blockchain data in a multi-level storage system, the method comprising:
receiving latest block data of a blockchain;
storing the latest block data in a first-level storage system of the multi-level storage system, the multi-level storage system comprising the first-level storage system and at least one lower-level storage system configured to archive block data previously stored in the first-level storage system;
determining that a block data migration event for the first-level storage system is triggered; and
in response to determining that the block data migration event for the first-level storage system is triggered, migrating at least a part of block data currently stored in the first-level storage system to the lower-level storage system.

2. The computer-implemented method of claim 1, wherein a single-chain connection way is established between different storage systems in the multi-level storage system.

3. The computer-implemented method of claim 2, wherein a storage performance of storage media corresponding to the first-level storage system and the at least one lower-level storage system in the multi-level storage system decreases in a gradient from the first-level storage system.

4. The computer-implemented method of claim 2, wherein the multi-level storage system comprises a plurality of lower-level storage systems, and wherein the method further comprises:
determining that at least one lower-level storage system of the plurality of lower-level storage systems receives at least a part of block data migrated from an upper-level storage system of the multi-level storage system;
in response to determining that the at least one lower-level storage system receives the at least part of block data migrated from the upper-level storage system, determining that a block data migration event for the at least one lower-level storage system is triggered; and
in response to determining that the block data migration event for the at least one lower-level storage systems is triggered, migrating at least a part of block data currently stored in one of the plurality of lower-level storage systems to a next level of the one of the plurality of lower-level storage systems.

5. The computer-implemented method of claim 4, wherein the block data migration event for the at least one lower-level storage system comprises:
a data capacity of block data currently stored in one or more of the at least one lower-level storage system exceeds a predetermined threshold; or
a capacity ratio of the data capacity of block data currently stored in one or more of the at least one lower-level storage systems to a total data capacity of the at least one lower-level storage system exceeds a predetermined threshold.

6. The computer-implemented method of claim 1, wherein a first storage performance of a first storage medium corresponding to the first-level storage system is higher than a second storage performance of a second medium corresponding to a second-level storage system of the at least one lower-level storage system.

7. The computer-implemented method of claim 1, wherein the block data migration event for the first-level storage system comprises:
a data capacity of the block data currently stored in the first-level storage system exceeds a predetermined threshold; or
a capacity ratio of the data capacity of the block data currently stored in the first-level storage system to a total data capacity of the first-level storage system exceeds a predetermined threshold.

8. A non-transitory, computer-readable medium storing one or more instructions executable by a computer system to perform operations comprising:
receiving latest block data of a blockchain;
storing the latest block data in a first-level storage system of a multi-level storage system, the multi-level storage system comprising the first-level storage system and at least one lower-level storage system configured to archive block data previously stored in the first-level storage system;
determining that a block data migration event for the first-level storage system is triggered; and
in response to determining that the block data migration event for the first-level storage system is triggered, migrating at least a part of block data currently stored in the first-level storage system to the lower-level storage system.

9. The non-transitory, computer-readable medium of claim 8, wherein a single-chain connection way is established between different storage systems in the multi-level storage system.

10. The non-transitory, computer-readable medium of claim 9, wherein a storage performance of storage media corresponding to the first-level storage system and the at least one lower-level storage system in the multi-level storage system decreases in a gradient from the first-level storage system.

11. The non-transitory, computer-readable medium of claim 9, wherein the multi-level storage system comprises a plurality of lower-level storage systems, and wherein the operations further comprise:
determining that at least one lower-level storage system of the plurality of lower-level storage systems receives at least a part of block data migrated from an upper-level storage system of the multi-level storage system;
in response to determining that the at least one lower-level storage system receives the at least part of block data migrated from the upper-level storage system, determining that a block data migration event for the at least one lower-level storage system is triggered; and
in response to determining that the block data migration event for the at least one lower-level storage systems is triggered, migrating at least a part of block data currently stored in one of the plurality of lower-level storage systems to a next level of the one of the plurality of lower-level storage systems.

12. The non-transitory, computer-readable medium of claim 11, wherein the block data migration event for the at least one lower-level storage system comprises:
a data capacity of block data currently stored in one or more of the at least one lower-level storage system exceeds a predetermined threshold; or
a capacity ratio of the data capacity of block data currently stored in one or more of the at least one lower-level storage systems to a total data capacity of the at least one lower-level storage system exceeds a predetermined threshold.

13. The non-transitory, computer-readable medium of claim 8, wherein a first storage performance of a first storage medium corresponding to the first-level storage system is higher than a second storage performance of a second medium corresponding to a second-level storage system of the at least one lower-level storage system.

14. The non-transitory, computer-readable medium of claim 8, wherein the block data migration event for the first-level storage system comprises:
a data capacity of the block data currently stored in the first-level storage system exceeds a predetermined threshold; or
a capacity ratio of the data capacity of the block data currently stored in the first-level storage system to a total data capacity of the first-level storage system exceeds a predetermined threshold.

15. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
receiving latest block data of a blockchain;
storing the latest block data in a first-level storage system of a multi-level storage system, the multi-level storage system comprising the first-level storage system and at least one lower-level storage system configured to archive block data previously stored in the first-level storage system;
determining that a block data migration event for the first-level storage system is triggered; and
in response to determining that the block data migration event for the first-level storage system is triggered, migrating at least a part of block data currently stored in the first-level storage system to the lower-level storage system.

16. The computer-implemented system of claim 15, wherein a single-chain connection way is established between different storage systems in the multi-level storage system.

17. The computer-implemented system of claim 16, wherein a storage performance of storage media corresponding to the first-level storage system and the at least one lower-level storage system in the multi-level storage system decreases in a gradient from the first-level storage system.

18. The computer-implemented system of claim 16, wherein the multi-level storage system comprises a plurality of lower-level storage systems, and wherein the operations further comprise:
determining that at least one lower-level storage system of the plurality of lower-level storage systems receives at least a part of block data migrated from an upper-level storage system of the multi-level storage system;
in response to determining that the at least one lower-level storage system receives the at least part of block data migrated from the upper-level storage system, determining that a block data migration event for the at least one lower-level storage system is triggered; and
in response to determining that the block data migration event for the at least one lower-level storage systems is triggered, migrating at least a part of block data currently stored in one of the plurality of lower-level storage systems to a next level of the one of the plurality of lower-level storage systems.

19. The computer-implemented system of claim 18, wherein the block data migration event for the at least one lower-level storage system comprises:
a data capacity of block data currently stored in one or more of the at least one lower-level storage system exceeds a predetermined threshold; or
a capacity ratio of the data capacity of block data currently stored in one or more of the at least one lower-level storage systems to a total data capacity of the at least one lower-level storage system exceeds a predetermined threshold.

20. The computer-implemented system of claim 15, wherein a first storage performance of a first storage medium corresponding to the first-level storage system is higher than a second storage performance of a second medium corresponding to a second-level storage system of the at least one lower-level storage system.
